(19) United States
(12) Patent Application Publication
(10) Pub. No.: US 2010/0084310 A1
(43) Pub. Date: Apr. 8, 2010

(54) CHIP CARD HOLDER

(75) Inventors: LUCAS HUANG, Shenzhen City (CN); CHIEN-CHUN HUANG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (Hong Kong) Limited, Kowloon (HK)

(21) Appl. No.: 12/547,699

(22) Filed: Aug. 26, 2009

(30) Foreign Application Priority Data
Oct. 8, 2008 (CN) 200810304776.7

(51) Int. Cl. G11B 33/04; B65D 85/90

(52) U.S. Cl. 206/706; 206/723

(57) ABSTRACT

An exemplary chip card holder used in a portable electronic device for holding a chip card is provided. The chip card holder includes a body member, a latching piece and a releasing piece. The body member includes a bottom wall and a first sidewall perpendicularly protrudes from the bottom wall. The latching piece is disposed on the first sidewall opposite to the bottom wall to resist against a chip card assembled within the chip card holder. The releasing piece is disposed on the bottom wall opposite to the first sidewall and is configured to form a receiving space together with the bottom wall and the first side wall to accommodate the chip card. The releasing piece is configured to selectively lock and release the chip card.

### BACKGROUND

1. Technical Field

The exemplary disclosure generally relates to a chip card holder for a portable electronic device.

2. Description of Related Art

With the development of wireless technology, portable electronic devices are becoming widely used and multifunctional. Portable electronic devices such as mobile phones typically have chip cards (e.g., SIM card) for storing usable information. It is necessary to provide chip card holders for holding/securing the chip card within the portable electronic device.

The chip card holder usually defines a receiving space and a holding member. The chip card can be partially received and held in the receiving space by the holding member. Accordingly, the chip card has an exposed portion which is not received in the receiving space. The exposed portion is used for the removal (e.g., to be pulled by users) of the chip card out of the receiving space. However, the exposed portion is usually too small and therefore difficult for a user to grasp in removing the chip card from the holder.

Therefore, there is room for improvement within the art.

### BRIEF DESCRIPTION OF THE DRAWINGS

Many aspects of the exemplary chip card holder can be better understood with reference to the following drawings. These drawings are not necessarily drawn to scale, the emphasis instead being placed upon clearly illustrating the principles of the present methods. Moreover, in the drawings like reference numerals designate corresponding parts throughout the several views. Wherever possible, the same reference numbers are used throughout the drawings to refer to the same or like elements of an embodiment.

FIG. 1 shows a perspective view of a chip card holder according to an exemplary embodiment.

FIG. 2 shows a perspective view of the chip card holder shown in FIG. 1, wherein, a chip card is partially accommodated within the receiving space of the chip card holder.

FIG. 3 shows a perspective view of the chip card holder shown in FIG. 1, wherein, the chip card is assembled and accommodated within the receiving space of the chip card holder.

FIG. 4 shows a cross-sectional view taken along line IV-IV of FIG. 2.

FIG. 5 shows a cross-sectional view taken along line V-I of FIG. 3.

### DETAILED DESCRIPTION

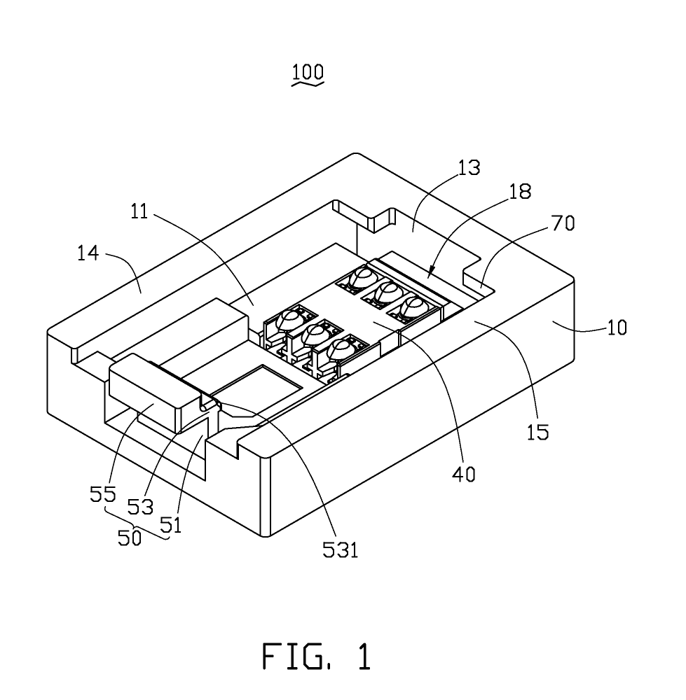

FIG. 1 shows an exemplary chip card holder 100 used in a portable electronic device (e.g., a mobile phone). The chip card holder 100 is used to hold a chip card 90 therein and includes a body member 10, a releasing piece 50 and a latching piece 70.

The body member 10 may be part of a housing of a portable electronic device. In the present embodiment, the body member 10 includes a bottom wall 11 and a substantially U-shaped peripheral sidewall (not labeled) extending from the peripheral edge of the bottom wall 11 perpendicularly. The peripheral sidewall includes a first sidewall 13, a second sidewall 14 connects with one end of the first sidewall 13 perpendicularly and a third sidewall 15 connects with the other end of the first sidewall 13 perpendicularly and parallel to the second sidewall 14. There is an elastic card connector 40 disposed on the bottom wall 11 of the body member 10 to electrically connect with the chip card 90 assembled within the body member 10.

The releasing piece 50 is made of elastic material and is disposed on the bottom wall 11 of the body member 10 opposite to the first sidewall 13, thus, the releasing piece 50, the bottom wall 11, the first sidewall 13, the second sidewall 14 and the third sidewall 15 together form a receiving space 18. The receiving space 18 is for receiving the chip card 90 therein. In the present embodiment, the releasing piece 50 is disposed on the bottom wall 11 by injection molding. The releasing piece 50 includes a connecting portion 51, a latching portion 53 and a pressing portion 55. The connecting portion 51 extends from the bottom wall 11 perpendicularly and parallel to the first sidewall 13. The latching portion 53 and the pressing portion 55 are both disposed at the distal end of the connecting portion 51 away from the bottom wall 11. The latching portion 53 extends out from the inner side of distal end of the connecting portion 51 toward the first sidewall 13 and is configured to hold or lock the chip card 90 assembled within the receiving space 18. The latching portion 53 defines a wedge shaped incline 531 opposite to the first sidewall 13, the incline 531 is configured to direct the chip card 90 into receiving space 18 of the body member 10. The pressing portion 55 is substantially L-shaped extending out from the outer side of distal end of the connecting portion 51 backward the first sidewall 13 and is configured to release the chip card 90 form the receiving space 18 of body member 10 to a released position.

The latching piece 70 is disposed at the end portion of the first sidewall 13 parallel and opposite to the bottom wall 11 and accommodated within the receiving space 18 to resist against a chip card 90 assembled within the receiving space 18. In the present embodiment, the latching piece 70 includes two spaced-apart protrusions perpendicularly extending outwardly from the two sides of the distal end of the first sidewall 13 and opposite to the bottom wall 11. It is to be understood, the latching piece 70 also could be an elastic sheet, a jaw or other latching structures.

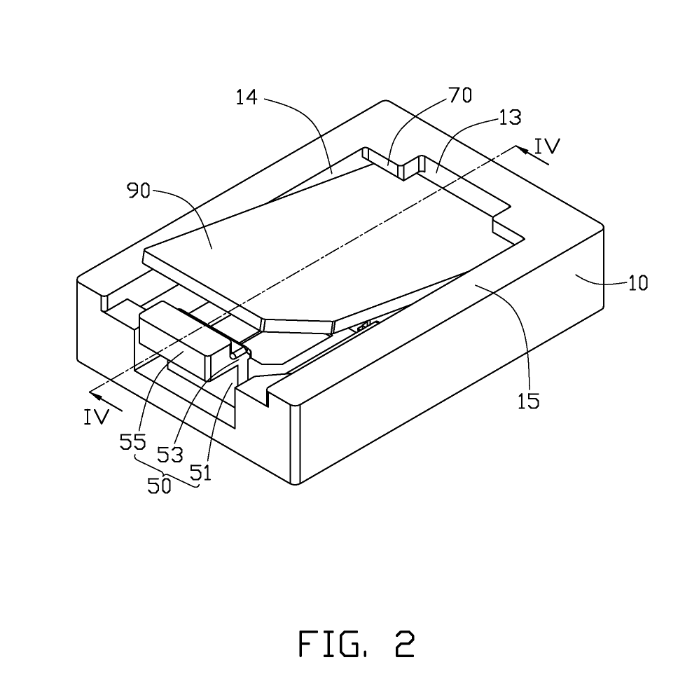

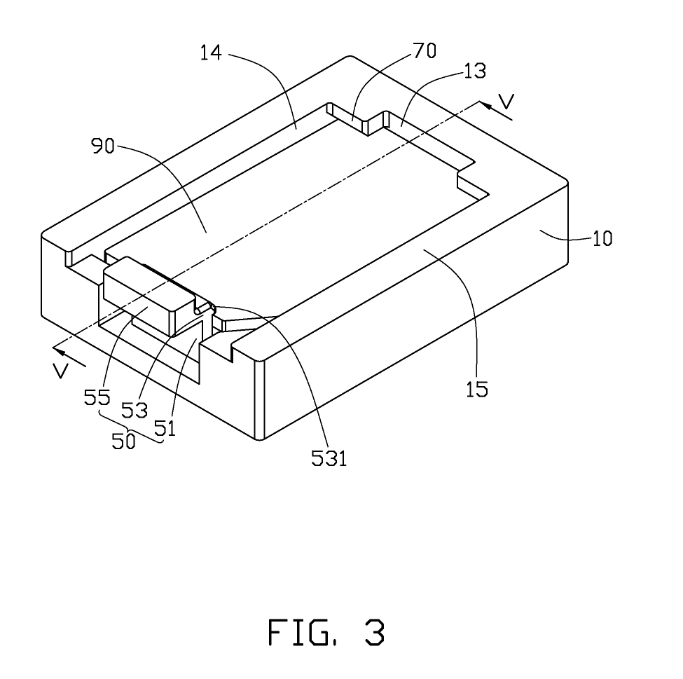

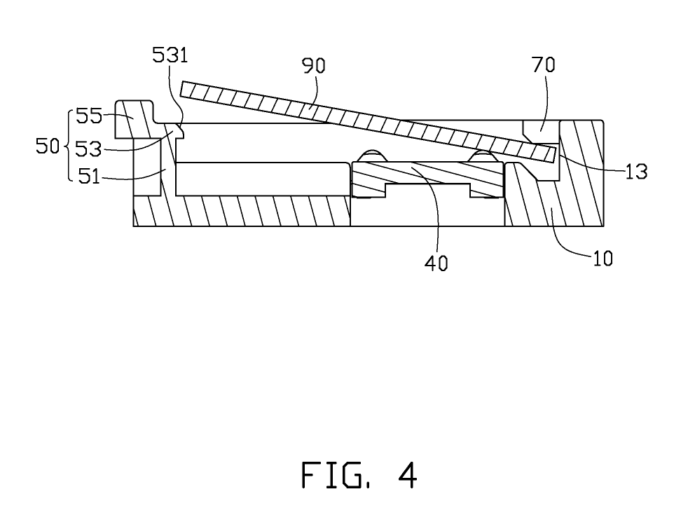

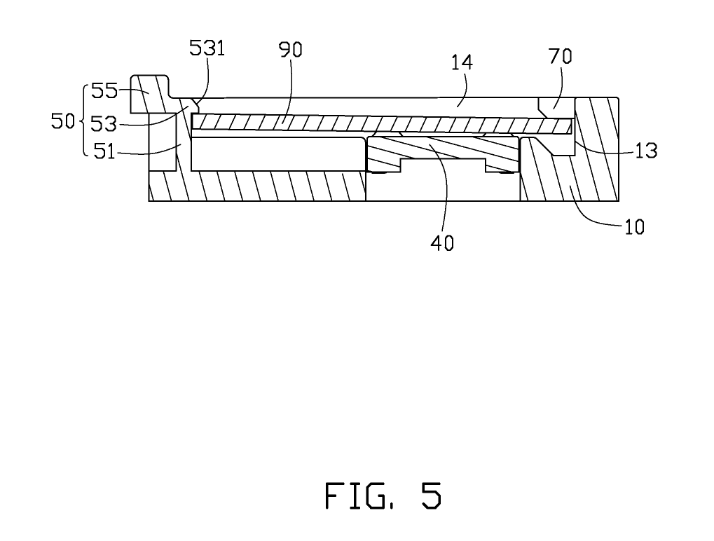

Also referring to FIGS. 2-5, when assembling the chip card 90 to the chip card holder 100, one end of the chip card 90 is inserted into the receiving space 18 of the body member 10 and resist against the latching piece 70. The opposite other end of the chip card 90 is positioned or located upon the releasing piece 50. The pressing portion 55 of the releasing piece 50 is pressed downwardly and pulled out far away from the receiving space 18, and then, the connecting portion 51 of the releasing piece 50 is deformed and moves away from the receiving space 18 so as to assemble the other end of the chip card 90 into the receiving space 18. The other end of the chip card 90 is pressed downwardly until the whole chip card 90 slides into the receiving space 18 along the wedge shaped incline 531 and electrically connects/contacts with the elastic card connector 40 disposed on the bottom wall 11 of the receiving space 18. The releasing piece 50 is released to returns to its original position and the latching portion 53 latches tightly on the other end of the chip card 90 to prevent the chip card 90 departing from the receiving space 18 of the body member 10. Thus, the chip card 90 is tightly locked and accommodated within the receiving space 18 by the latching portion 53 of the releasing piece 50 and the latching piece 70.

To release the chip card 90 from the chip card holder 100, the releasing piece 50 is deflected by an operator pressing and pulling the pressing portion 55. Thus, the latching portion 53 releases the other end of the chip card 90 and, the other end of the chip card 90 is pushed out of the receiving space by the elastic card connector 40 and exposed out from the receiving space 18. Then, the chip card 90 is taken out easily and the releasing piece 50 is released to return back to its original position.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A chip card holder for accommodating and holding a chip card assembled therein, comprising:
a body member comprising a bottom wall and a first sidewall perpendicularly protruding from the bottom wall;
a latching piece disposed on the first sidewall opposite to the bottom wall to resist against a chip card assembled within the chip card holder; and
a releasing piece disposed on the bottom wall opposite to the first sidewall and being configured to form a receiving space together with the bottom wall and the first side wall to accommodate the chip card; the releasing piece being configured to selectively lock and release the chip card.

2. The chip card holder as claimed in claim 1, wherein the releasing piece includes a connecting portion and a latching portion, the connecting portion perpendicularly extends from the bottom wall and generally parallel to the first sidewall; the latching portion is disposed at the distal end of the connecting portion toward the first sidewall side and is configured to hold or lock the chip card.

3. The chip card holder as claimed in claim 2, wherein the releasing piece further includes a pressing portion extending out from the connecting portion and is configured to release the chip card form the receiving space to a released position.

4. The chip card holder as claimed in claim 1, wherein the releasing piece is made of elastic material and disposed on the bottom wall by injection molding.

5. The chip card holder as claimed in claim 1, wherein the latching piece includes two protrusions spacingly extending outwardly from the two sides of the distal end of the first sidewall.

6. The chip card holder as claimed in claim 2, wherein the latching portion defines a wedge shaped incline opposite to the first sidewall, the incline is configured for directing the chip card into the receiving space.

7. The chip card holder as claimed in claim 2, wherein the body member further includes a second sidewall perpendicularly connects with one end of the first sidewall and a third sidewall perpendicularly connects with the other end of the first sidewall and parallel to the second sidewall; the releasing piece, the bottom wall, the first sidewall, the second sidewall and the third sidewall form the receiving space.

8. The chip card holder as claimed in claim 7, wherein the chip card holder further includes an elastic card connector disposed on the bottom wall thereof to electrically connect with the chip card assembled within the body member and provides a elastic force to push the chip card out of the receiving space as the releasing piece is released.

9. A chip card holder used in a portable electronic device for holding a chip card comprising:
a body member defining a receiving space to accommodate the chip card therein;
a latching piece disposed at one end of the body member to prevent the chip card exiting the receiving space; and
a releasing piece disposed at the opposite end of the body member and being configured to selectively lock and release the chip card.

10. The chip card holder as claimed in claim 9, wherein the body member includes a bottom wall and a substantially U-shaped peripheral sidewall perpendicularly extending from the bottom wall; the releasing piece, the bottom wall and the peripheral side wall form the receiving space.

11. The chip card holder as claimed in claim 10, wherein the peripheral sidewall includes a first sidewall, a second sidewall perpendicularly connects with one end of the first sidewall and a third sidewall perpendicularly connects with the other end of the first sidewall and parallel to the second sidewall; the releasing piece is made of elastic material and includes a connecting portion and a latching portion, the connecting portion perpendicularly extends from the bottom wall and parallel to the first sidewall; the latching portion is disposed at the distal end of the connecting portion toward the first sidewall side and is configured to selectively hold or lock the chip card.

12. The chip card holder as claimed in claim 11, wherein the releasing piece further includes a pressing portion extending out from the connecting portion and is configured to release the chip card form the receiving space of body member to a released position.

13. The chip card holder as claimed in claim 12, wherein the latching piece includes two spaced-apart protrusions extending perpendicularly outwardly from the two sides of the distal end of the first sidewall and opposite to the bottom wall.

14. The chip card holder as claimed in claim 13, wherein the chip card holder further includes an elastic card connector disposed on the bottom wall thereof to electrically connect with the chip card assembled within the body member and provides a elastic force to push the chip card out of the receiving space as the releasing piece is released.
